(19) United States
(12) Patent Application Publication
(10) Pub. No.: US 2019/0138310 A1
(43) Pub. Date: May 9, 2019

(54) METHOD FOR READING OUT VARIABLES FROM AN FPGA

(71) Applicant: dSPACE digital signal processing and control engineering GmbH, Paderborn (DE)

(72) Inventors: Heiko Kalte, Paderborn (DE); Dominik Lubeley, Paderborn (DE)

(21) Appl. No.: 16/182,637

(22) Filed: Nov. 7, 2018

(30) Foreign Application Priority Data
Nov. 8, 2017 (DE) 102017126094.3

(51) Int. Cl. G06F 9/30; G06F 17/50

(52) U.S. Cl. CPC G06F 9/30116; G06F 17/5022

(57) ABSTRACT

A method for reading variables from a Field Programmable Gate Array (FPGA) at runtime includes: calculating, in the FPGA, a first variable, wherein the first variable is associated with a first shadow register and a second shadow register, and wherein the first variable is associated with a first measurement grid and with a second measurement grid; synchronously storing, at a first point in time, all variables associated with the first measurement grid in shadow registers associated with the respective variables; synchronously storing, at a second point in time, all variables associated with the second measurement grid in shadow registers associated with the respective variables; and reading out the shadow registers independently of one another.

### CROSS-REFERENCE TO RELATED APPLICATIONS

Priority is claimed to German Patent Application No. DE 102017126094.3, filed on Nov. 8, 2017, the entire disclosure of which is hereby incorporated by reference herein.

### BACKGROUND

The real-time simulation of complex, dynamic models places high demands even on modern computing nodes due to the tight time constraints. In automotive hardware-in-the-loop simulations (HiL), such models are mainly used where fast control loops have to be closed. This is the case, for example, in the simulation of internal cylinder pressure sensors, which play an increasingly important role in reducing fuel consumption or exhaust emissions. But short cycle times and low latencies are also desirable for controlled systems with high dynamics, such as electric motors. These can practically no longer be implemented with CPU-based simulations.

Field Programmable Gate Arrays (FPGAs) can support computing nodes in real-time simulation by taking over computing of dynamic parts of a model. Due to the high flexibility and the possibility of parallel processing of signals, FPGAs can also be used to easily meet hard real-time requirements. The FPGAs can serve as hardware accelerators for CPUs of computing nodes. Accordingly, very dynamic parts of the environment model, for example, are stored in the FPGA so that sufficiently precise and fast response times for the ECU are guaranteed. An FPGA netlist is usually generated based on an FPGA model in a hardware description language in a build process.

The models of a controlled system are becoming increasingly complex and therefore difficult to handle due to increasing demands on accuracy. In the automotive HiL environment such models are usually created using the toolset Matlab/Simulink from The MathWorks Inc. Simulink provides a block-based view of such models in the form of a block diagram. Model parts can be combined into subsystems in a block diagram and linked to each other with signals. The data flow between these blocks is displayed via signal lines.

An FPGA-based simulation can be modelled in a block diagram with Simulink using the Xilinx System Generator (XSG) and dSPACE's FPGA Programming Blockset, analogous to CPU-based simulation.

In contrast to CPU simulation, this model is not translated into an iterative programming language, but into an FPGA netlist that describes a customer-specific digital circuit. The FPGA netlist can be translated into an FPGA configuration data stream. The FPGA configuration data stream configures an FPGA such that the circuit defined by the model at runtime is performed.

From DE102013101300A1 a method for accessing a signal value of an FPGA at runtime is known.

### SUMMARY

In an exemplary embodiment, the present invention provides a method for reading variables from a Field Programmable Gate Array (FPGA) at runtime. The method includes: calculating, in the FPGA, a first variable, wherein the first variable is associated with a first shadow register and a second shadow register, and wherein the first variable is associated with a first measurement grid and with a second measurement grid; synchronously storing, at a first point in time, all variables associated with the first measurement grid in shadow registers associated with the respective variables; synchronously storing, at a second point in time, all variables associated with the second measurement grid in shadow registers associated with the respective variables; and reading out the shadow registers independently of one another.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an FPGA program with one variable and two shadow registers connected in parallel;

FIG. 2 shows an FPGA program with one variable and two shadow registers connected in parallel and an internal memory trigger;

FIG. 3 shows an FPGA program with two variables and two shadow registers connected in parallel for each variable;

FIG. 4 shows an FPGA program with one variable and two shadow registers connected in series;

FIG. 5 shows an FPGA program with two variables and two shadow registers connected in series for each variable;

FIG. 6 shows a “stage counter” for two measurement grids with shadow registers connected in series;

FIG. 7 shows an FPGA program with “stage counter”; and

FIGS. 8a and 8b show a chronological sequence of a procedure in accordance with exemplary embodiments of the invention.

### DETAILED DESCRIPTION

In the following some terms are explained in the way they are to be understood herein.

Reading out a variable here is understood as reading out a value of the variable stored in a register at a certain point in time. The storage of a variable in a register is understood as the storage of the current value of the variable in a register. Variables can contain any number of bits and be distributed over several registers.

A shadow register is understood to be a register that is not necessary for the computations performed in the FPGA, but that can store values of variables independently of the current computations. The values stored in the shadow registers are not included in the current computations. Reading out of the shadow registers can be carried out using various known techniques. For example, shadow registers can be read out via a “readback mechanism” present in the FPGA. The “readback mechanism” is characterized by the fact that the outputs of the shadow registers do not have to be connected further. Consequently, no wiring effort is necessary for the implementation of the readout technology. In an alternative version, the shadow registers are connected via one or more multiplexers to an IO pin of the FPGA. This means that considerably fewer IO pins are required for readout than shadow registers. In an alternative version, the shadow registers are connected to an address decoder. The shadow registers can be read out individually via the address decoder.

A measurement grid is understood here as periodic, aperiodic or sporadic triggering of a storage and readout process.

Herein, synchronous or simultaneous means in particular that two or more actions take place in the same computing step in clocked computations. For example, the FPGA may contain a clock generator or be connected to a clock generator, wherein the clock signal from the clock generator causes the variables to be updated. Before another clock signal updates the variables again, all simultaneous or synchronous actions, e.g. synchronous storage of several variables, are performed.

A trigger signal is understood to be a signal that triggers a predetermined action. A trigger signal can, for example, cause a variable to be stored in a shadow register. Such a trigger signal can, for example, be distributed via a clock network in the FPGA. A clock network is usually used to distribute a clock signal from a clock generator and thereby control a clocked computation in the FPGA as described above. Since a large number of clock networks can be implemented in an FPGA, one or more clock networks can be used to monitor the computation and further clock networks can be used to distribute the trigger signals.

An exemplary embodiment of the present invention provides a method for reading out of a data processing device with a processor unit and an FPGA, wherein the data processing device is designed to perform the above method. Another exemplary embodiment of the present invention provides a computer program product with computer-implemented instructions which, after loading and executing in a suitable data processing device, executes the steps of the above procedure and a digital storage medium with electronically readable control signals which can interact with a programmable data processing device in such a way that the above procedure is performed.

An exemplary embodiment of the invention provides a method for reading variables from an FPGA at runtime, wherein a first variable is calculated in the FPGA, wherein the first variable is associated with a first shadow register and a second shadow register, wherein the first variable is associated with a first measurement grid, wherein at a first point in time the first measurement grid causes synchronous storage of all variables associated with the first measurement grid in a shadow register associated with the respective variables, wherein the first variable is associated with a second measurement grid, wherein at a second point in time the second measurement grid causes synchronous storage of all variables associated with the second measurement grid in a shadow register associated with the respective variable, wherein the shadow registers are read out independently of one another.

One advantage of this method is that the measurement points of the measurement grids can be located in close chronological succession to each other, since the second value can be stored before the first value has been read out. Via the independent readout the faster needed value can be read out first, regardless of the value that was stored first. It is therefore not necessary to read out the firstly stored value before the second value is stored, nor is it necessary to read out the firstly stored value before the second value.

It will be appreciated that the number of shadow registers can be increased. The number can be specified directly or indirectly by the user when creating the FPGA program. An indirect specification can, for example, be made by specifying the number of measurement grids that are to be usable at runtime.

A processor unit can be connected to the FPGA to form a data processing device and can be used to control the readout. For this purpose, the processor unit can address a readback mechanism present in the FPGA. Alternatively, a logic for outputting the stored variables that are controllable by the processor unit can be implemented in the FPGA program. Such a controllable logic can be, for example, an address decoder via which the individual shadow registers are addressable.

In an advantageous configuration, a second variable is computed in the FPGA, wherein a third shadow register is associated with the second variable, wherein the second variable is associated with the first measurement grid, wherein at the first point in time the second variable is stored synchronously with the first variable.

The advantage here is that the values of both variables are simultaneously stored. Herein, synchronous or simultaneous means in particular that both variables are stored in the same clock step during a clocked computation in the FPGA. So, the FPGA is connected to a clock generator or has an internal clock generator and in each clock step the values of the variables are updated. The first measurement grid causes two variable values which are present in the same clock step to be stored in two shadow registers.

In an advantageous configuration, the first shadow register and the second shadow register are connected in parallel.

In this case, connected in parallel means that both registers receive the same variable as data input. Storage can be caused independently for both shadow registers. For example, the first shadow register can receive a different trigger signal than the second shadow register.

In a particularly advantageous configuration, the first measurement grid stores the value of the first variable in the first shadow register and the second measurement grid stores the value of the first variable in the second shadow register.

The advantage is that each shadow register is permanently associated with a measurement grid. In a special configuration, a large number of variables receive the same number of parallel shadow registers. The number of shadow registers then determines the number of possible measurement grids. The fixed association facilitates an easy readout of the shadow registers, since each shadow register is associated with a variable and a measurement grid. For each measurement grid a separate trigger signal can be implemented to the associated shadow registers. Herein, a trigger signal is to be understood as a signal that is triggered by the measurement grid and causes the value present at the input of the shadow register to be stored. The value is then kept in the shadow register until another trigger signal arrives. Such a trigger signal can be implemented, for example, in the form of a clock network. A clock network is usually used to monitor a clocked computation in the FPGA. Since a large number of clock networks can be implemented in an FPGA, one or more clock networks can be used to monitor the computation and further clock networks can be used to distribute the trigger signals.

It will be appreciated that a larger number of shadow registers can be connected in parallel. The more parallel shadow registers are implemented, the more measurement grids with their own trigger signal can be used. In a configuration, the number of parallel shadow registers implemented for each variable is directly specified by the user when creating the FPGA program. In an alternative configuration, the number of measurement grids that is usable at runtime is specified by the user when creating the FPGA program and a shadow register is implemented for each measurement grid for each variable. For each measurement grid a clock network is implemented to distribute the trigger signal and for each variable the shadow register associated with the respective measurement grid is connected to the respective clock network.

In an alternative configuration, the first shadow register and the second shadow register are connected in series.

Herein, connected in series means that a data output of the first shadow register is connected to a data input of the second shadow register. Thus, the second shadow register can incorporate the value stored in the first shadow register. Both shadow registers are controlled with the same trigger signal.

The advantage of this configuration is that both measurement grids use the same trigger signal. Therefore, a single signal may be used for both measurement grids. This makes it possible to use more measurement grids than clock networks are available for the distribution of trigger signals. In one configuration, more shadow registers are implemented as measurement grids. For example, twice as many shadow registers as measurement grids can be implemented per variable. The number of measurement grids can be specified by the user.

In a further configuration, the first measurement grid and the second measurement grid cause the first variable to be stored in the first shadow register, wherein the value stored in the first shadow register is shifted to the second shadow register, wherein the association of the shadow registers to the measurement grids is updated accordingly.

Updating the association of the shadow registers to the measurement grids can for example take place in the form of a “stage counter”. The “Stage Counter” indicates at any time which shadow register is associated with which measurement grid. The trigger signal of the respective measurement grid is transmitted to the “Stage Counter” and the association is updated. The first shadow register is thus associated with the first measurement grid at the first point in time and to the second measurement grid at the second point in time.

With a further trigger signal, the value stored in the second shadow register is lost. Therefore, it is advantageous to implement more shadow registers connected in series. Then, for a trigger signal the value stored in a shadow register is shifted to the next shadow register, respectively. In an advantageous configuration, the number of measurement grids usable at runtime is specified by the user and twice as many shadow registers are implemented for each variable as are specified for the measurement grids.

In a further configuration, a trigger signal 10 is associated with each measurement grid.

Each measurement grid triggers the trigger signal associated with it. If the shadow registers are implemented in parallel, the trigger signal is only forwarded to the shadow registers associated with the measurement grid. If the shadow registers are implemented in series, the trigger signal is forwarded to all shadow registers and, if necessary, to a “stage counter”.

In an advantageous design, the configuration of the first variable to a measurement grid is changed at runtime.

The association of the variables to the measurement grids determines which shadow registers are read out. By changing the association at runtime, the readout effort can be adjusted dynamically, since only those shadow registers are read out whose contents are required. The change can be the association with the second measurement grid, the association with a third measurement grid, or the association with no measurement grid.

In one configuration, a readout process comprises the readout of all variables linked to a measurement grid that were stored synchronously at a certain point in time.

In an advantageous configuration, the readout sequence of the shadow registers is determined in a pre-emptive procedure.

The advantage of pre-emptive processes is that one readout process can be interrupted by another readout process. This means that data required at short notice can be read out more quickly, as there is no need to wait for the current readout process to start. The interrupted readout process can be restarted at the breakpoint and does not have to be repeated completely. Preemptive procedures are known.

In an alternative configuration, the readout sequence is determined in a non-preemptive procedure.

Non-preemptive procedures are advantageous if interrupting and/or starting readout processes means additional time and/or implementation effort. In non-preemptive procedures, readout processes are always performed entirely and are not interrupted. Non-preemptive procedures are known.

In a configuration, at least one measurement grid periodically causes a storage.

Periodic storage of the variables is advantageous if the data is to be further processed in a periodic computation. For example, the computations in the FPGA can be related to a simulation on a processor, wherein the simulation is computed in periodic time steps, wherein the variables from the FPGA are required for predetermined time steps.

In one configuration, at least one measurement grid causes aperiodic or sporadic storage.

Aperiodic or sporadic storage is advantageous if the data are only required from time to time, e.g. when predetermined conditions occur. Such conditions can be, for example, certain computation results of the FPGA computations or events such as the arrival of external signals from components connected to the FPGA or the request by a user.

In a configuration, the data stored by a measurement grid are read out in a predetermined period of time.

The readout in a predetermined period of time is advantageous if the readout values are to be further processed in a real-time context. For example, the data processing device can carry out a real-time simulation or make the read-out values available to a real-time simulation.

FIG. 1 depicts an FPGA program 100 implemented on an FPGA. An FPGA program is often created as a block diagram in a graphical programming environment. A block diagram is depicted in FIG. 1. The FPGA program 100 has a data input 101 that flows into the FPGA program 100 via the input data. The data is processed in a first logic block 102 to a first variable 1. The first variable is forwarded to a second logic block 103, a first shadow register 2 and a second shadow register 3. The second logic block 103 generates output data from the first variable 1, which is output via a data output 105. A clock block 104 supplies a clock signal to the first logic block 102 and the second logic block 103. The clock block can be part of the FPGA program (as depicted), implemented outside the FPGA program in the FPGA, or a clock signal can be directed to the FPGA program from outside. With each clock step, the first logic block 102 generates a new value for the first variable 1. At a first point in time t1, a signal from a first measurement grid 4 causes the first shadow register 2 to store the current value of the first variable 1. At a second point in time t2, a signal from a second measurement grid 5 causes the second shadow register 3 to store the current value of the first variable 1. The values stored in shadow registers 2, 3 can be read out independently of each other. The readout can, for example, take place via a readback mechanism. The readback mechanism is not part of the FPGA program and is therefore not displayed. When creating the FPGA program, it may be necessary to allow access via the readback mechanism. For example, when converting a program code or block diagram into a configuration bit stream, it may be necessary to explicitly consider access via the readback mechanism. The first point in time and the second point in time can be anywhere in relation to each other. It is possible that the second point in time t2 occurs during the readout of the first shadow register 2.

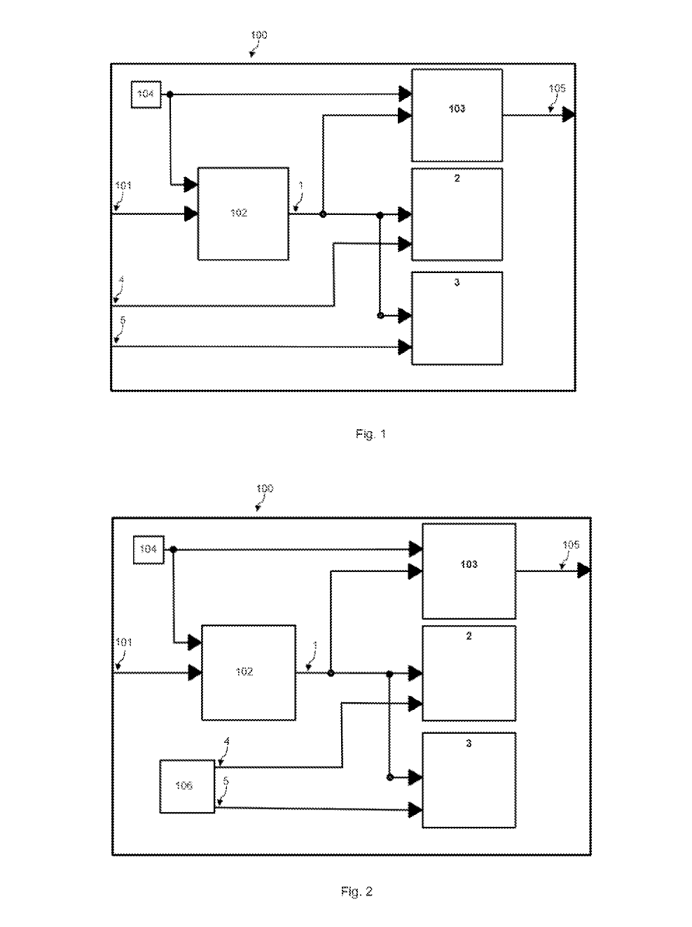

FIG. 2 depicts an alternative FPGA program 100. In the following, differences relative to FIG. 1 are described. The signal of the first measurement grid 4 and the signal of the second measurement grid 5 are generated here within the FPGA program 100 by a measurement grid block 106. For example, the measurement grid block can be configured during the initialization of the FPGA program 100 and can regularly generate the signal of the first measurement grid 4 and the signal of the second measurement grid 5 during the runtime of the FPGA program 100.

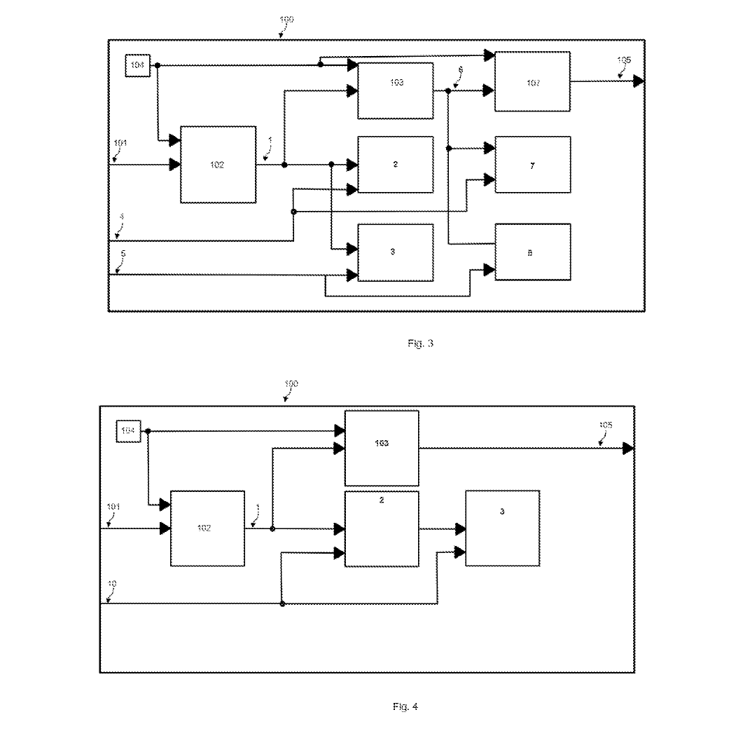

FIG. 3 depicts an alternative FPGA program 100. In the following, differences relative to FIG. 1 are described. The second logic block 103 generates a second variable 6. The second variable 6 is forwarded to a third logic block 107, a third shadow register 7 and a fourth shadow register 8. The third logic block generates output data which is output via data output 105. The clock signal of clock block 104 is also supplied to the third logic block 107. The signal of the first measurement grid 4 causes the first shadow register 2 to store the current value of the first variable 1 and the third shadow register 7 to store the value of the second variable 6. The signal of the second measurement grid 5 causes the second shadow register 3 to store the current value of the first variable 1 and the fourth shadow register 8 to store the value of the second variable 6. The four shadow registers 2, 3, 7, 8 can be read out independently of each other. It can be provided that several shadow registers are read out in one readout process. For example, the first shadow register 2 and the third shadow register 7 can be read out in a first readout process and the second shadow register 3 and the fourth shadow register 8 can be read out in a second readout process. Depending on the intended technology for the readout, it may not be possible to carry out several readout processes at the same time. In this case, the readout processes are carried out one after the other. It is also possible that one readout process is interrupted by another and is continued later. For example, the first readout process can first read out the first shadow register, then be interrupted by the second readout process, and after the second readout process has read out the second shadow register and the fourth shadow register, the first readout operation reads out the third shadow register. This is advantageous if the data of the second readout process are required faster than the data of the first readout process. If only the first variable but not the second variable is associated with the second measurement grid, only the second shadow register is read out in the second readout process.

FIG. 4 depicts an alternative FPGA program 100. In the following, differences relative to FIG. 1 are described. The first variable 1 is forwarded to the second logic block 103 and the first shadow register 2. The output of the first shadow register 2 is connected to the input of the second shadow register 3. The signals of the first measurement grid and the second measurement grid are distributed via a common line 10. The signal of the first measurement grid on the common line 10 causes at a first point in time t1 that the first variable is stored in the first shadow register 2. At a second point in time t2, the signal of the second measurement grid on the common line 10 causes the value stored in the first shadow register 2 to be stored in the second shadow register 3 and the first variable 1 to be stored in the first shadow register 2. The value stored at the first point in time t1 is therefore not lost but is moved to the second shadow register 3 and the current value is stored in the first shadow register 2.

FIG. 5 depicts an alternative FPGA program 100. In the following, differences relative to FIG. 4 are described. The second logic block 103 generates a second variable 6. The second variable 6 is forwarded to a third logic block 107 and a third shadow register 7. The output of the third shadow register 7 is connected to the input of the fourth shadow register 8. The third logic block 107 generates output data which is output via data output 105. The clock signal of clock block 104 is also supplied to the third logic block 107.

The signal of the first measurement grid 4 is applied to the common line 10 in a combination block 106. At a first point in time t1, the common signal 10 causes the first variable to be stored in the first shadow register 2 and the second variable 6 to be stored in the third shadow register 7. The signal of the second measurement grid 5 is also applied to the common line 10 in combination block 106. At a second point in time t2, the common signal 10 causes the value stored in the first shadow register 2 to be stored in the second shadow register 3, the first variable 1 to be stored in the first shadow register 2, the value stored in the third shadow register 7 to be stored in the fourth shadow register 8 and the second variable 6 to be stored in the third shadow register 7. The value stored at the second point in time t2 is therefore not lost but moved to the fourth shadow register 8 and the current value of the second variable is stored in the third shadow register 7.

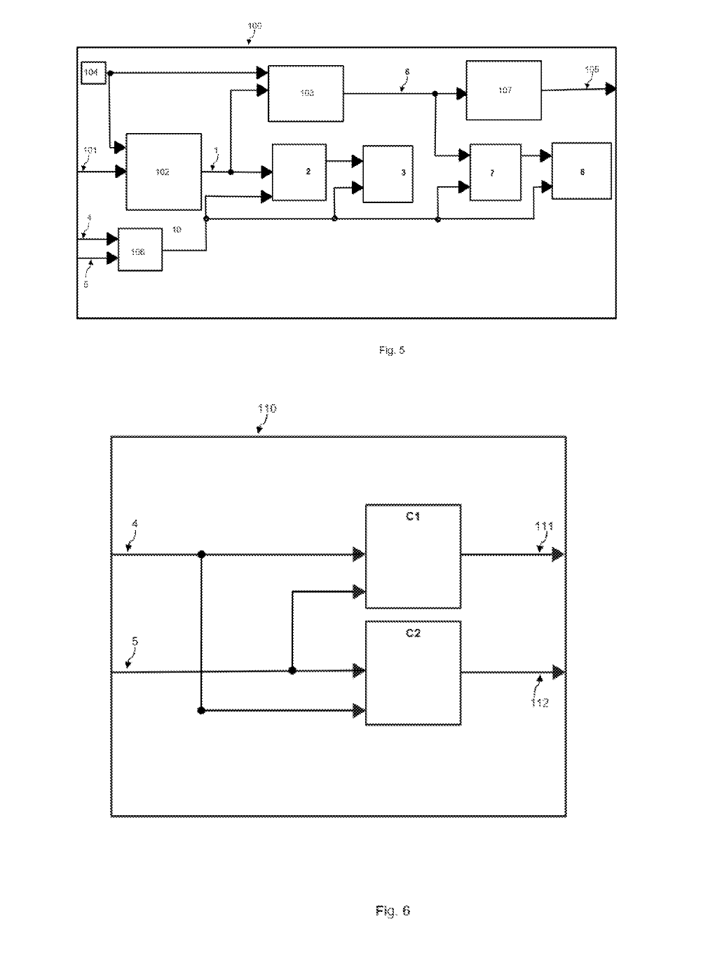

FIG. 6 shows a “Stage Counter”. A “Stage Counter” 110 is able to record the association of the shadow registers with the measurement grids of serially implemented shadow registers as in FIGS. 4 and 5. In the “Stage Counter” 110 a first counter C1 and a second counter C2 are implemented. The first counter C1 outputs a first counter value of 111 and the second counter C2 outputs a second counter value of 112. The first counter value 111 indicates in which of the shadow registers associated with a variable the last value stored by the first grid 4 is stored. The second counter value 112 indicates in which shadow register associated with a variable the last value stored by the second grid 5 is stored. At the first point in time t1, the signal of the first measurement grid 4 causes the first counter C1 to output 111 “one” as the first counter value and the second counter C2 to increase the second counter value 112 by one. The first counter value 111 thus indicates that the first variable 1 stored by the first measurement grid 4 at the first point in time t1 is stored in the first shadow register 2 and can be read out from there. At the second point in time t2, the signal of the second measurement grid 5 causes the first counter C1 to increase the first counter value 111 by one and the second counter C2 to output 112 “one” as the second counter value. The first counter value 111 thus indicates that the first variable 1 stored by the first measurement grid 4 at the first point in time t1 is stored in the second shadow register 3 and can be read out from there. The second counter value 112 thus indicates that the first variable 1 stored by the second measurement grid 5 at the second point in time t2 is stored in the first shadow register 2 and can be read out from there. In FIG. 5, the third shadow register 7 is analogous to the first shadow register and the fourth shadow register 8 is analogous to the second shadow register in relation to the second variable 6. The counter values for the second variable are to be interpreted accordingly. For more measurement grids more counters are implemented in the “Stage Counter”. If a counter value exceeds the number of shadow registers in series implemented for a variable, the value for the corresponding measurement grid is lost. It is therefore advantageous to implement a large number of shadow registers. For example, twice as many shadow registers as measurement grids can be implemented per variable.

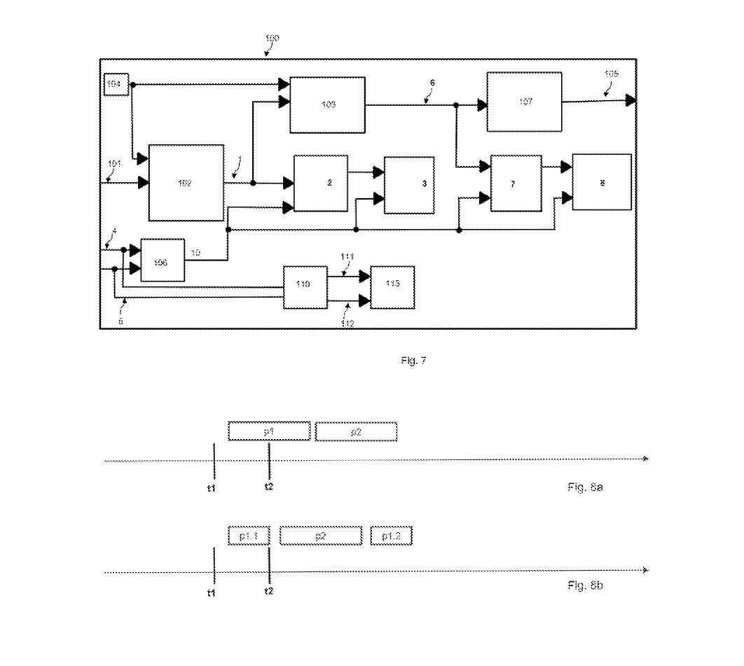

FIG. 7 depicts an alternative FPGA program 100. In the following, differences relative to FIG. 5 are described. The signals of the first measurement grid 4 and the second measurement grid 5 are forwarded not only to the combination block 106 but also to the “stage counter” 110. The first counter value 111 and the second counter value 112 are forwarded to a readout logic 113. The readout logic 113 determines which shadow registers are read out. The readout logic 113 can be connected to the readback mechanism or make the information available to another readout mechanism.

FIG. 8a shows a chronological sequence of a procedure in accordance with an exemplary embodiment of the invention. At a point in time t1, the first measurement grid 4 causes the variables associated with the first measurement grid 4 to be stored in a shadow register associated with the respective variable. During an initial time period p1, the shadow registers associated with the first grid 4 are read out. Within the first time period p1 there is a second point in time t2. At the second point in time t2, the second measurement grid 5 causes the variables associated with the second measurement grid 5 to be stored in a shadow register associated with the respective variable. During a second time period p2, the shadow registers associated with the second grid 5 are read out. Herein, the second time period p2 is completely behind the first time period p1.

FIG. 8b shows an alternative chronological sequence of a procedure in accordance with an exemplary embodiment of the invention. In the following, differences relative to FIG. 8a are described. The first time period p1 is divided herein into a first section p1.1 before the second time period p2 and a second section p1.2 after the second time period p2. With reference to the FPGA program from FIG. 3, for example, the first shadow register 2 can first be read out in the first section p1.1 before the second time period p2, the second shadow register 3 can be read out in the second time period p2 and the third shadow register 7 can be read out in the second section p1.2 after the second time period p2. With reference to the FPGA program 100 from FIG. 1, for example, the first variable 1 can have a large number of bits and be stored at the first point in time t1 in a large number of shadow registers which together form the first shadow register 2. In the first section of the first time period p1.1 a part of the first shadow register 2 is read out, in the second time period p2 the second shadow register 3 is read out and in the second section of the first time period p1.2 the remaining part of the first shadow register 2 is read out. With reference to the FPGA program 100 from FIG. 5, for example, at the first point in time t1 the first variable 1 can be stored in the first shadow register 2 and the second variable 6 in the third shadow register 7. In the first section of the first time period p1.1, the third shadow register 7 is read out. At the second point in time t2, the value of the first shadow register 2 is shifted to the second shadow register 3, that of the third shadow register 7 is shifted to the fourth shadow register 8, the first variable is stored in the first shadow register 2 and the second variable 6 is stored in the third shadow register 7. The association of the shadow registers to the measurement grids is updated accordingly. In the second time period p2, the first shadow register 2 and the third shadow register 7 are read out. In the second section of the first time period p1.2, the second shadow register 3 is read out.

Several FPGA programs 100 may be run simultaneously on one FPGA. For each individual FPGA program 100, a procedure in accordance with exemplary embodiments of the invention can be used independently of the others. Several FPGA programs 100 can share a clock signal of a clock block 104 or work with different clock signals. An FPGA program 100 can also be a subprogram of a larger FPGA program 100.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for reading variables from a Field Programmable Gate Array (FPGA) at runtime, comprising:
calculating, in the FPGA, a first variable, wherein the first variable is associated with a first shadow register and a second shadow register, and wherein the first variable is associated with a first measurement grid and with a second measurement grid;
synchronously storing, at a first point in time, all variables associated with the first measurement grid in shadow registers associated with the respective variables;
synchronously storing, at a second point in time, all variables associated with the second measurement grid in shadow registers associated with the respective variables; and
reading out the shadow registers independently of one another.

2. The method according to claim 1, further comprising:
computing, in the FPGA, a second variable, wherein a third shadow register is associated with the second variable, wherein the second variable is associated with the first measurement grid, and wherein at the first point in time the second variable is stored synchronously with the first variable.

3. The method according to claim 1, wherein the first shadow register and the second shadow register are connected in parallel.

4. The method according to claim 3, wherein the first measurement grid causes the first variable to be stored in the first shadow register and the second measurement grid causes the first variable to be stored in the second shadow register.

5. The method according to claim 1, wherein the first shadow register and the second shadow register are connected in series.

6. The method according to claim 5, wherein the first measurement grid and the second measurement grid cause the first variable to be stored in the first shadow register, wherein the value stored in the first shadow register is shifted into the second shadow register at the second point in time, and wherein the association of the shadow registers to the measurement grids is updated accordingly.

7. The method according to claim 1, wherein a trigger signal is associated with each measurement grid.

8. The method according to claim 1, wherein the association of the first variable to a measurement grid is changed at runtime.

9. The method according to claim 1, wherein the readout sequence of the shadow registers is determined in a pre-emptive procedure

10. The method according to claim 1, wherein the readout sequence of the shadow registers is determined in a non-preemptive procedure.

11. The method according to claim 1, wherein a readout process comprises the readout of all variables associated with a measurement grid and stored synchronously at a point in time.

12. The method according to claim 1, wherein at least one measurement grid periodically causes storage.

13. The method according to claim 1, wherein at least one measurement grid causes storage aperiodically or sporadically.

14. The method according to claim 1, wherein the data stored by a measurement grid are read out in a predetermined period of time.

15. The method according to claim 1, wherein the shadow registers are read out via a readback mechanism.

16. A data processing device comprising a processor and a Field Programmable Gate Array (FPGA), wherein the processor and the FPGA are configured to facilitate: calculating, in the FPGA, a first variable, wherein the first variable is associated with a first shadow register and a second shadow register, and wherein the first variable is associated with a first measurement grid and with a second measurement grid;
synchronously storing, at a first point in time, all variables associated with the first measurement grid in shadow registers associated with the respective variables;
synchronously storing, at a second point in time, all variables associated with the second measurement grid in shadow registers associated with the respective variables; and
reading out the shadow registers independently of one another.

17. A non-transitory computer-readable medium having processor-executable instructions stored thereon for reading variables from a Field Programmable Gate Array (FPGA) at runtime, the processor-executable instructions, when executed, facilitating performance of the following:
calculating, in the FPGA, a first variable, wherein the first variable is associated with a first shadow register and a second shadow register, and wherein the first variable is associated with a first measurement grid and with a second measurement grid;
synchronously storing, at a first point in time, all variables associated with the first measurement grid in shadow registers associated with the respective variables;
synchronously storing, at a second point in time, all variables associated with the second measurement grid in shadow registers associated with the respective variables; and
reading out the shadow registers independently of one another.
